(19) United States
(12) Patent Application Publication
(10) Pub. No.: US 2024/0374449 A1
(43) Pub. Date: Nov. 14, 2024

(54) SACROILIAC JOINT CORRECTION BED

(71) Applicant: Yasuhiko ISHIKAWA, Takamatsu-shi (JP)

(72) Inventor: Yasuhiko ISHIKAWA, Takamatsu-shi (JP)

(21) Appl. No.: 18/453,551

(22) Filed: Aug. 22, 2023

(30) Foreign Application Priority Data
May 10, 2023 (JP) 2023-077624

(51) Int. Cl. A61G 13/00; A61H 1/00

(52) U.S. Cl. CPC A61G 13/009; A61H 1/008; A61H 2201/0138; A61H 2201/1619; A61H 2201/164; A61H 2201/1664; A61H 2201/1676; A61H 2205/088

(57) ABSTRACT

A sacroiliac joint correction bed provided with a lumbar support that supports a lower back, a chest support and a leg support. The lumbar support comprises four bases that respectively correspond to a left ilium, a right ilium, a left ischium, and a right ischium of the patient, and four holding mechanisms each of which exists between each of pairs of the bases and the supporting bodies, each of the holding mechanisms is provided with a main body fixed to the base and a holding member movable up and down on the main body so that the holding member takes an ascended portion and a descended position. When the holding member descends to the descended position by applying an impact force to the supporting body, two of the left supporting bodies are arranged to oppose each other, and two of the right supporting bodies are arranged to oppose each other.

### TECHNICAL FIELD

This invention relates to a sacroiliac joint correction bed.

### BACKGROUND

Known as a conventional bed used for correcting sacroiliac joint misalignment is a treatment table disclosed in Patent Document 1 for example. This treatment table is provided with a lumbar support that supports the lower back of a patient lying down, and the lumbar support is provided with multiple divided members that are divided in the axial and width directions of the patient's body, and supporting bodies that support the divided members so as to allow them to move individually up and down. Each supporting body is provided with a lift means that lifts a divided member and a holding means that holds the ascended divided member at a specified drop height, and is configured so that if an impact force is applied from above to the divided member held by the holding means, this divided member drops.

### RELATED ART

[Patent Doc. 1] JP Patent 6609082

### Problem(s) to be Solved

Although the conventional treatment table mentioned above can apply an impact force to a desired part of the lower back by appropriately selecting the divided members to drop, because each divided member drops vertically, there was room for further improvement in correcting three-dimensional misalignment of the left and right sacroiliac joints.

Then, the objective of this invention is to offer a sacroiliac joint correction bed that can effectively correct sacroiliac joints with an inexpensive configuration.

### SUMMARY

The above objective is realized with a sacroiliac joint correction bed provided with a lumbar support that supports a lower back equipped between a chest support and a leg support that respectively support a chest and legs of a patient in a prone posture, wherein the lumbar support comprises four bases that are arranged in a matrix in front-back and left-right directions and installed individually movable up and down, four supporting bodies that are in a plate shape, attached freely pivotable around horizontal axes to the bases, and respectively correspond to a left ilium, a right ilium, a left ischium, and a right ischium of the patient to support, and four holding mechanisms each of which exists between each of pairs of the bases and the supporting bodies, each of the holding mechanisms is provided with a main body fixed to the base and a holding member that is installed movable up and down on the main body so that the holding member takes an ascended portion when being up and a descended position when being down, and configured to hold the supporting body in an inclined state in the ascended position, and configured to pivot the supporting body into a horizontal state from the inclined state when the holding member descends to the descended position by applying an impact force to the supporting body, and in the inclined state, two of the supporting bodies, which support the left ilium and the left ischium, are arranged to oppose each other, and two of the supporting bodies, which support the right ilium and the right ischium, are arranged to oppose each other.

It is preferred that the sacroiliac joint correction bed the back-side supporting body is formed to have a larger area than the front-side supporting body, and a space (S1) between the front-side and back-side supporting bodies is 10˜30 mm, and defining two of the supporting bodies that are placed adjacent in a left-right direction as a left-side supporting body in the left side and a right-side supporting body in the right side, a space (S2) between the left-side and right-side supporting bodies is a 50˜70 mm. Herein, two of the supporting bodies that are placed adjacent in the front-back direction are defined as a front-side supporting body in the front side and a back-side supporting body in the back side.

It is preferred that, in the sacroiliac joint correction bed, a distance from the descended position to the ascended position of the holding members is 10˜30 mm.

This invention can offer a sacroiliac joint correction bed that can effectively correct the sacroiliac joints with an inexpensive configuration.

### BRIEF DESCRIPTION OF THE DRAWINGS

FIG. 1 is a perspective view of a sacroiliac joint correction bed of an embodiment of this invention.

FIG. 2 is a plan view of the main part of FIG. 1.

FIG. 3 is a side view of FIG. 1.

FIG. 4A and FIG. 4B are cross-sectional views of the main part of FIG. 3.

FIG. 5A and FIG. 5B are operational diagrams of the main part of FIG. 3.

### DETAILED DESCRIPTION OF PREFERRED EMBODIMENT

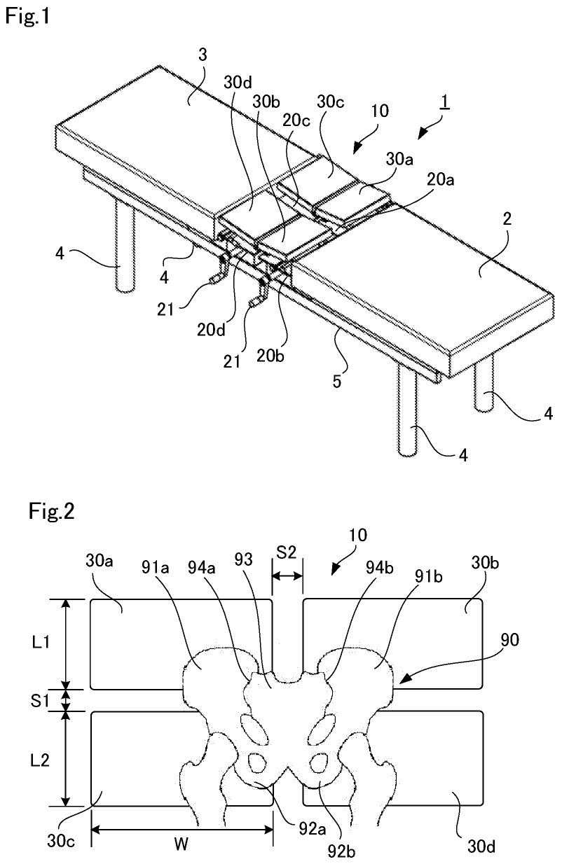

Below, an embodiment of this invention is explained referring to attached drawings. FIG. 1 is a perspective view of a sacroiliac joint correction bed of the embodiment of this invention. As shown in FIG. 1, the sacroiliac joint correction bed 1 is provided with a chest support 2, a lumber support 10, and a leg support 3 that respectively support the chest, lower back, and legs of a patient lying prone, where the lumbar support 10 is arranged between the chest support 2 and the leg support 3. The left and right sides of the chest support 2, the lumbar support 10, and the leg support 3 are supported by multiple legs 4 through band plates 5.

The lumbar support 10 is provided with four bases 20a, 20b, 20c, and 20d arranged in a matrix in the front-back (longitudinal) and left-right (wide) directions, four supporting bodies 30a, 30b, 30c, and 30d attached to the top of the bases 20a, 20b, 20c, and 20d, respectively. The four supporting bodies 30a, 30b, 30c, and 30d are rectangular flat plate shape members having a cushioning characteristic.

FIG. 2 is a plan view of the lumbar support 10 shown in FIG. 1. As shown in FIG. 2, the four supporting bodies 30a, 30b, 30c, and 30d are arranged in a matrix matching the standard size of the pelvis 90 of the lower back, and support the left ilium 91a, the right ilium 91b, the left ischium 92a, and the right ischium 92b, respectively. The two supporting bodies 30a and 30b arranged in the front side (the side of the chest support 2 in FIG. 1) are formed in the same size and shape with each other. The two supporting bodies 30c and 30d arranged in the back side (the side of the leg support 3 in FIG. 1) are formed in the same size and shape with each other so that their front-back direction length L2 becomes longer than the front-back direction length L1 of the two supporting bodies 30a and 30b in the front side. The widths W of the supporting bodies 30a, 30b, 30c, and 30d are the same.

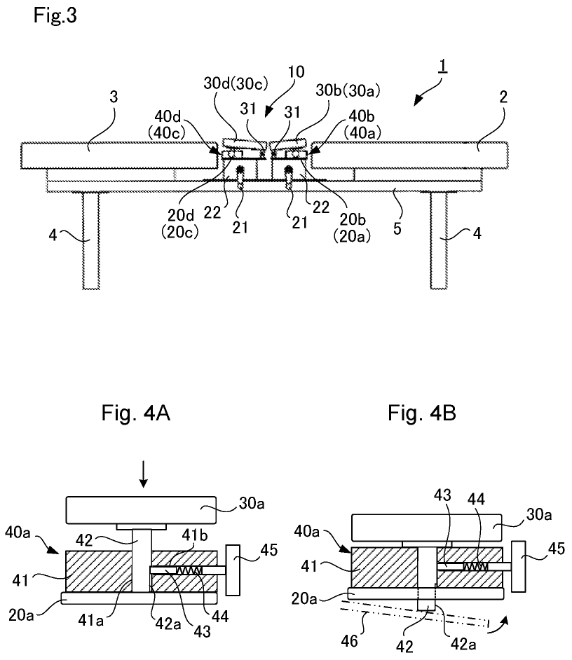

FIG. 3 is a side view of the sacroiliac joint correction bed 1 shown in FIG. 1. As shown in FIG. 3, the bases 20a, 20b, 20c, and 20d are supported individually movable up and down on pantograph-type lifting stages 22 fixed to the band plate 5, and each can be held at an arbitrary position within a specified height range (e.g., the supporting bodies 30a, 30b, 30c, and 30d are from a state flush with the chest support 2 and the leg support 3 to the maximum ascended position of about 10 cm) by the rotational operation of a handle 21.

The supporting bodies 30a, 30b, 30c, and 30d are supported freely pivotable/rotatable around horizontal axes 31 on the bases 20a, 20b, 20c, and 20d, respectively, and can be rotated so that their top faces change from a horizontal state to an inclined state. In the inclined states of the supporting bodies 30a, 30b, 30c, and 30d shown in FIG. 3, the front-back adjacent supporting bodies 30a and 30c, and the supporting bodies 30b and 30d oppose each other, respectively. The horizontal axes 31 are arranged extending parallel to the width direction of the bed. As shown in FIG. 3, the “oppose each other” does not necessarily mean facing each other in parallel. It includes a configuration in which two of the supporting bodies 30a to 30d, which are arranged in the front-back direction (or longitudinal direction) of the bed, inclines at 3 to 30 degrees with respect to the plane of the horizontal state of the bed, and the pair faces each other.

Also, as shown in FIG. 3, the lumber support 10 is provided with four holding mechanisms 40a, 40b, 40c, and 40d that exist between the bases 20a, 20c, 20c, and 20d and the supporting bodies 30a, 30b, 30c, and 30d, respectively, and hold the supporting bodies 30a, 30b, 30c, and 30d in inclined states, respectively.

FIG. 4A and FIG. 4B are outline cross-sectional views of the holding mechanism 40a seen from the chest support 2 side. As shown in FIG. 4A, the holding mechanism 40a is provided with a main body 41 fixed to the base 20a, and a cylindrical holding member 42 installed movable up and down in a through hole 41a of the main body 41. Formed on the outer circumference surface of the holding member 42 is a groove-shaped notch 42a that extends from the central part to the tip. Accommodated in a horizontal hole 41b that communicates with the through hole 41a of the main body 41 is an engaging piece 43. The engaging piece 43 has its tip protrude into the through hole 41a and engage with the notch 42a by a bias force of an elastic member 44 comprising a spring or the like, and can hold the holding member 42 in the ascended position. Thereby, as shown in FIG. 3, the supporting body 30a is held in an inclined state. Note that the other holding mechanisms 40b, 40c, and 40d are also configured in the same manner as the holding mechanism 40a mentioned above.

When a downward (an arrow direction) impact force is applied to the supporting body 30a shown in FIG. 4A, the engaging piece 43 moves rightward against the bias force of the elastic member 44, and the engaging piece 43 and the notch 42a become disengaged. Thereby, as shown in FIG. 4B, the holding member 42 descends to a descended position with its lower end protruding downward of the main body 41, and the supporting body 30a drops onto the top face of the main body 41 and becomes horizontal. The bias force of the elastic member 44 can be adjusted as appropriate by advancing/retracting an adjusting screw 45 screwed into the horizontal hole 41b so that the supporting body 30a drops with a desired impact force. For holding the supporting body 30a in an inclined state again, pushing up the holding member 42 makes the engaging piece 43 engaged with the notch 42a. Pushing up the holding member 42 can also be performed by installing a reset lever 46 shown in two-dot chain lines in FIG. 4B and pushing up the reset lever 46.

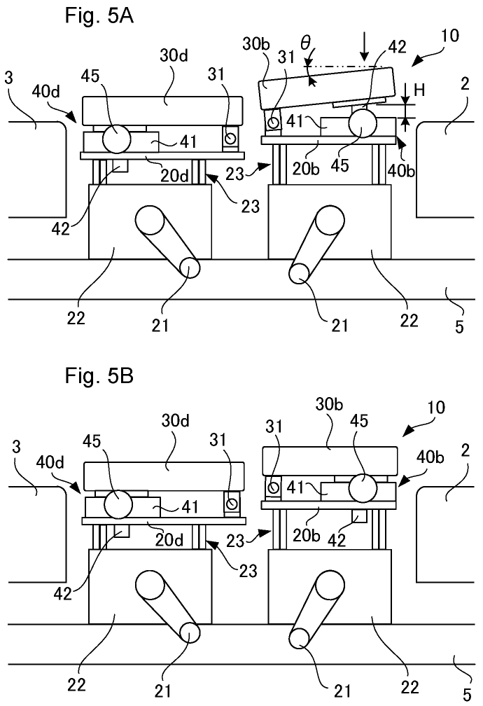

In the sacroiliac joint correction bed 1 provided with the configuration mentioned above, as shown in FIG. 2, after aligning the pelvis 90 of a patient lying prone so as to be supported by the supporting bodies 30a, 30b, 30c, and 30d, the height positions of the bases 20a, 20b, 20c, and 20d shown in FIG. 1 are individually adjusted by the operation of a link arm 23 by a practitioner operating the handle 21. Then, as shown in FIG. 5A, after operating the holding mechanism 40b so that the supporting body corresponding to the patient's treated part (the supporting body 30b in this embodiment) comes into an inclined state, the patient's treated parts are pressed by hand. Thereby, with an impact force acting in the arrow direction, the holding member 42 descends, causing the supporting body 30b come into the horizontal state shown in FIG. 5B. The distance H from the descended position to the ascended position of the holding member 42 shown in FIG. 5A should preferably be 10˜30 mm, and more preferably be 20 mm. The inclination angle θ of the supporting body 30b relative to the horizontal plane in the inclined state should be 3˜10 degrees for example, and more preferably be 4˜7 degrees.

The sacroiliac joint correction bed 1 of this embodiment can individually adjust the height positions of the four supporting bodies 30a, 30b, 30c, and 30d by the up-down motions of the four bases 20a, 20b, 20c, and 20d, matching the sizes, directions, etc. of the shifts of the sacroiliac joints 94a and 94b between the left and right ilia 91a and 91b and the sacrum 93 shown in FIG. 2. Also, the supporting bodies 30a, 30b, 30c, and 30d are arranged so that those adjacent in the front-back direction (i.e., the supporting bodies 30a and 30c, and the supporting bodies 30b and 30d) oppose each other in inclined states, thereby when the patient's treated parts are pressed, by the supporting bodies 30a, 30b, 30c, and 30d corresponding to the treated parts rotate instead of simply drop, thereby corrective forces can be effectively applied to the left and right sacroiliac joints 94a and 94b.

When spaces S1 and S2 between the supporting bodies 30a, 30b, 30c, and 30d shown in FIG. 2 are too small, it becomes difficult to apply desired corrective forces to the sacroiliac joints 94a and 94b. On the other hand, if they are too large, the support of the pelvis 90 can easily become unstable. Therefore, the space between the front-back adjacent supporting bodies 30a and 30c (and the space between the supporting bodies 30b and 30d) S1 should preferably be 10˜30 mm, and more preferably be 20 mm. Also, the space between the left-right adjacent supporting bodies 30a and 30b (and the space between the supporting bodies 30c and 30d) S2 should preferably be 50˜70 mm, more preferably be 60 mm.

The back-side supporting bodies 30c and 30d should preferably have larger areas than the front-side supporting bodies 30a and 30b closer to the sacroiliac joints 94a and 94b, thereby it become easier to apply desired corrective forces to the sacroiliac joints 94a and 94b by the rotations of the front-side supporting bodies 30a and 30b while stably supporting the pelvis 90 with the back-side supporting bodies 30c and 30d. The front-back direction length L1 of the front-side supporting bodies 30a and 30b shown in FIG. 2 is 120˜150 mm for example, and the front-back length L2 of the back-side supporting bodies 30c and 30d is 160˜190 mm for example. Also, the width of supporting bodies 30a, 30b, 30c, and 30d is 210˜240 mm for example.

### LEGENDS

1: sacroiliac joint correction bed
2: chest support
3: leg support
10: lumber support
20a, 20b, 20c, 20d: bases
30a, 30b, 30c, 30d: supporting bodies
31: horizontal axis
40: holding mechanisms
41: main body
42: holding member

What is claimed is:

1. A sacroiliac joint correction bed provided with a lumbar support that supports a lower back equipped between a chest support and a leg support that respectively support a chest and legs of a patient in a prone posture, wherein
the lumbar support comprises
four bases that are arranged in a matrix in front-back and left-right directions and installed individually movable up and down,
four supporting bodies that are in a plate shape, attached freely pivotable around horizontal axes to the bases, and respectively correspond to a left ilium, a right ilium, a left ischium, and a right ischium of the patient to support, and
four holding mechanisms each of which exists between each of pairs of the bases and the supporting bodies,
each of the holding mechanisms is
provided with a main body fixed to the base and a holding member that is installed movable up and down on the main body so that the holding member takes an ascended portion when being up and a descended position when being down, and
configured to hold the supporting body in an inclined state in the ascended position, and
configured to pivot the supporting body into a horizontal state from the inclined state when the holding member descends to the descended position by applying an impact force to the supporting body, and
in the inclined state, two of the supporting bodies, which support the left ilium and the left ischium, are arranged to oppose each other, and two of the supporting bodies, which support the right ilium and the right ischium, are arranged to oppose each other.

2. The sacroiliac joint correction bed according to claim 1, wherein
defining two of the supporting bodies that are placed adjacent in the front-back direction as a front-side supporting body in the front side and a back-side supporting body in the back side, the back-side supporting body is formed to have a larger area than the front-side supporting body, and a space (S1) between the front-side and back-side supporting bodies is 10˜30 mm, and
defining two of the supporting bodies that are placed adjacent in a left-right direction as a left-side supporting body in the left side and a right-side supporting body in the right side, a space (S2) between the left-side and right-side supporting bodies is a 50˜70 mm.

3. The sacroiliac joint correction bed according to claim 1, wherein
a distance from the descended position to the ascended position of the holding members is 10˜30 mm.
